(19) United States
(12) Patent Application Publication
(10) Pub. No.: US 2018/0236365 A1
(43) Pub. Date: Aug. 23, 2018

(54) TWIN TABLE PLAY CENTER

(71) Applicant: The Simplay3 Company, Streetsboro, OH (US)

(72) Inventor: John Hradisky, Aurora, OH (US)

(21) Appl. No.: 15/899,763

(22) Filed: Feb. 20, 2018

Related U.S. Application Data
(60) Provisional application No. 62/461,014, filed on Feb. 20, 2017.

(51) Int. Cl. A63H 3/52; A47B 7/02; B29C 41/04

(52) U.S. Cl. CPC A63H 3/52; B29C 41/04; A47B 7/02

(57) ABSTRACT

A children's play center is generally comprised of a first table unit, a second table unit, and a table top component. Each of the first and second table top components are comprised of a pair of inner and outer supporting legs, as well as at least one attachment notch. The table top component contains at least two sets of receiving units which are located on either side thereof. The children's play center is capable of being configured in a number of different positions according to the relative placement of the first table unit, second table unit, and table top component with respect to one another.

### TECHNICAL FIELD

The present invention relates generally to children's play structures. More specifically, the present invention is directed to rotationally molded play structures of a versatile nature which are capable of being adapted, configured, or transformed for a number of different scenarios, purposes or environments, such as differing play conditions or the need for quick and efficient travel, transport or storage.

### BACKGROUND

The process of rotational molding has gradually worked its way into a number of different fields of technology. Among the many advantages associated with such a process of manufacture are the ability to create relatively large units which are comprised of a durable plastic material. While such units may not be able to achieve the fine tolerances associated with other forms of manufacture, such precision does not always play a critical role in the function of the final product. A field of technology which rotational molding has generally found great success is that of children's play structures.

Due to the vast number of ways in which children may seek entertainment, play areas such as sandboxes, jungle gyms and arts and crafts stations have always remained popular options. The ability to offer children the opportunity to take part in such activities involving similar types of play structures carries an added advantage of offering peace of mind to the parents in knowing that such structures are safe of any potential harms to the children. The use of such durable plastic materials, which lack any small or moving parts, satisfies this need.

However, in creating various types of children's play structures by way of a rotational molding process, the resulting units are often quite large, bulky, and difficult to transport and store efficiently. These problems have presented the manufacturers of such products with large shipping and other transportation related costs. It has thus become essential to formulate children's play structures which are capable of providing the benefits discussed above, while also being able to address the problems created by such storage and shipping needs, without sacrificing any of those previously mentioned benefits.

### SUMMARY

A children's play center is generally comprised of a first table unit, a second table unit, and a table top component. Each of the first and second table top components are comprised of a pair of inner and outer supporting legs, as well as at least one attachment notch. The table top component contains at least two sets of receiving units which are located on either side thereof. The children's play center is capable of being configured in a number of different positions according to the relative placement of the first table unit, second table unit, and table top component with respect to one another.

When placed in the closed position, the first and second table unit are placed substantially close to one another. The table top component is thus capable of being placed on top of the two table units such that it rests, or is affixed, thereto. When placed in the open position, or any variation thereof, the table units are placed at a distance away from one another which allows for the table top component to span the gap thereby created. When placed in the storage position, the first and second table units are capable of being inserted into one another such that they substantially create a single unit which is of a more compact nature than that of the previously mentioned configurations.

### BRIEF DESCRIPTION OF THE DRAWINGS

The accompanying drawings in the following description illustrate various embodiments of the present disclosure.

FIG. 1 is a front view of the present invention showing the children's play center in the closed position:

FIG. 2 is a side view of the present invention showing the children's play center in the closed position:

FIG. 3 is a top view of the present invention showing the children's play center in the closed position with the table top component present;

FIG. 4 is an alternative top view of the present invention showing the children's play center in the closed position in the absence of the table top component;

FIG. 5 is a top view of the present invention showing the children's play center in the open position with the table top component in a first position:

FIG. 6 is an alternative top view of the present invention showing the children's play center in the open position with the table top component in a second position:

FIG. 7 is a side view of the present invention showing the children's play center in the nested configuration;

FIG. 8 is a front view of the present invention showing the children's play center in the nested configuration;

FIG. 9 is a top view of the present invention showing the children's play center in the nested configuration;

FIG. 10 is a prospective view of the present invention showing the children's play center as it is in the process of being placed in the nested configuration;

FIG. 11 is an alternative prospective view of the present invention showing the children's play center as it is in the process of being placed in the nested configuration.

### DETAILED DESCRIPTION

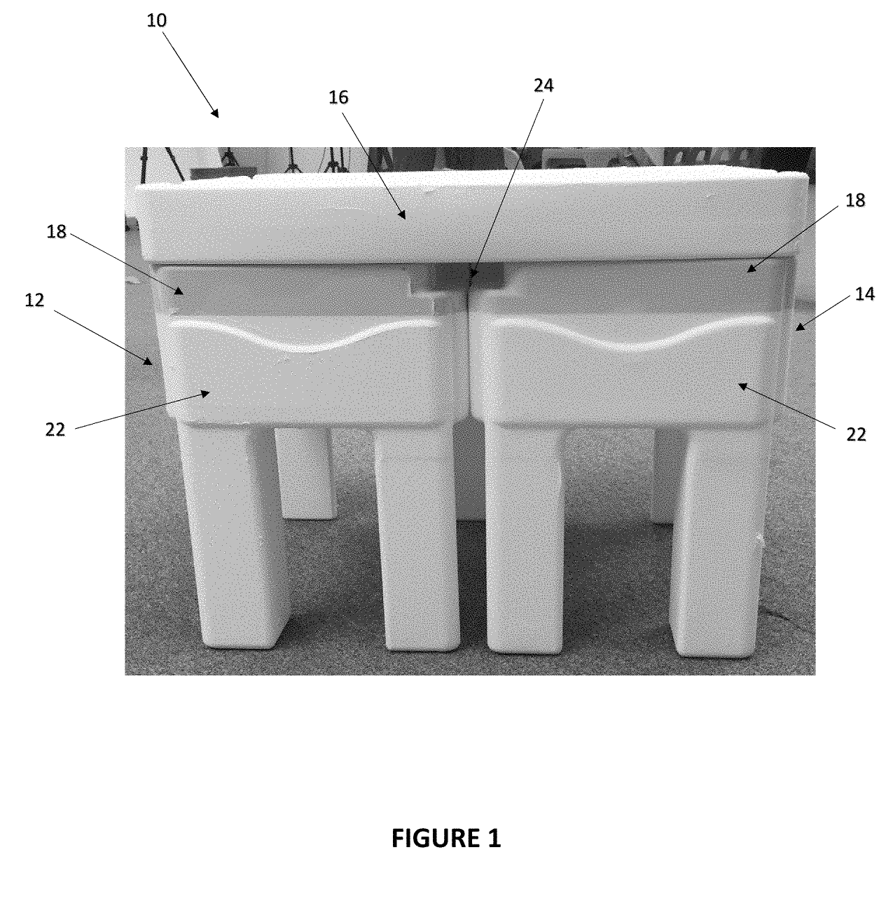

With reference to FIG. 1, a twin table play center, or children's play center 10, may be seen. The children's play center 10 may be generally defined by three central components: a first table unit 12, a second table unit 14, and a table top component 16. Each of the first table unit 12 and second table unit 14 may be further defined by the presence of a top surface 18 which rests upon a series of supporting legs. According to the embodiment shown in FIG. 1, each of the first table unit 12 and second table unit 14 are comprised of a top surface 18 which rests upon a series of four unique supporting legs. The supporting legs may be connected directly to that of the top surface 18, or may be connected to an intermediate structure 22 which acts so as to conjoin that of the supporting legs to that of the top surface 18. The intermediate structure 22 may feature any different number of designs, either structural or facial, which contribute to the overall aesthetic appearance of the children's play center 10 without departing from the scope of the present disclosure.

With continued reference to FIG. 1, the general shape of that of either the first table unit 12 or second table unit 14 may be rectangular in nature. Such a shape will result in the width of either the first or second table units 12, 14 being less than that of their respective length. Additional embodiments of the present invention, however, may utilize either a first table unit 12 or a second table unit 14 which is of a different shape or structure, such as that of a square, circle, oval, or any other geometric shape which is so desired.

The table top component 16 may be positioned such that it is substantially supported by that of each of the first table unit 12 and second table unit 14. The means for which the table top component 16 is affixed or secured to that of each of the respective table units 12, 14 will be discussed in further detail throughout the remainder of the present disclosure. When the first table unit 12 is placed next to that of the second table unit 14 such that the two units are either in contact with one another, or substantially in contact with one another, and the table top component 16 is placed thereon, as shown in FIG. 1, the children's play center 10 may be characterized as being in the closed position. The junction at which the first table unit 12 and second table unit 14 meet, characterized as being roughly at the midway point of the table top component 16 when placed in the closed position, may result in a gap 24. The gap 24 may be the result of each of the respective corners of the first and second table units 12, 14 having a cutaway portion. The cutaway portion on each of the respective table units 12, 14 may function as a means of identifying the proper orientation of the table units 12, 14 with respect to one another so as to properly align said units for the purposes of the placing the children's play center 10 in the closed position.

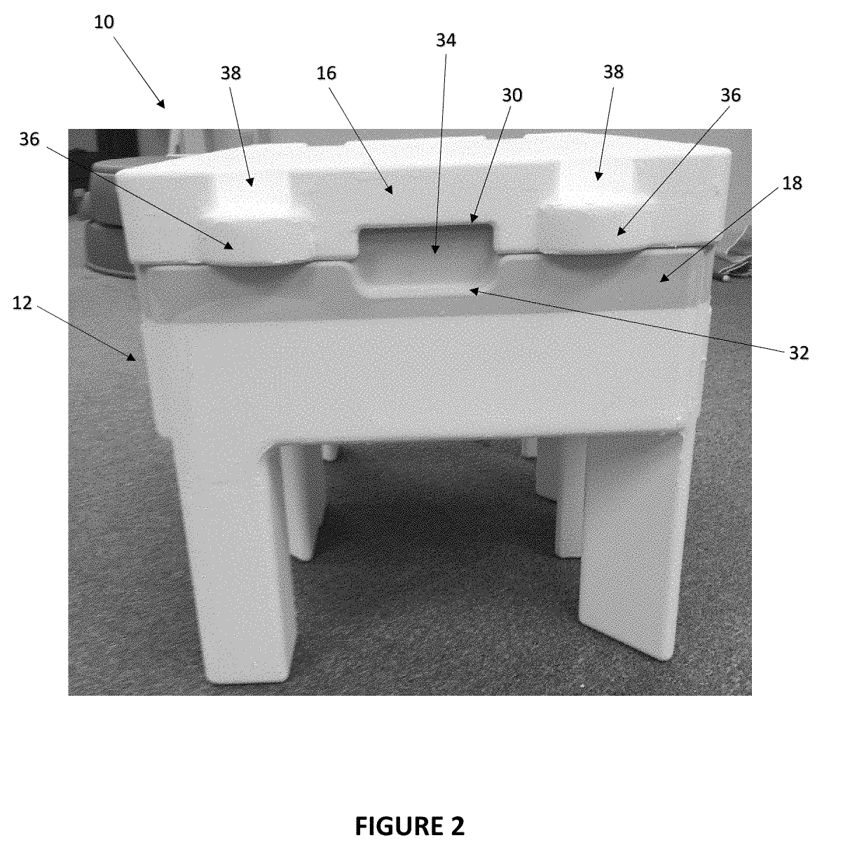

With reference now to FIG. 2, the children's play center 10 may be seen from an alternative angle when placed in the closed position. The table top component 16 may again be seen resting on that of the table units 12, 14, despite the fact that only one of such units is visible in the present figure. While FIG. 2 will hereinafter reference that of the first table unit 12 as being depicted, it should be noted that any such references thereto are meant to apply with equal weight and force to that of the second table unit 14, as if the children's play center 10 were being viewed from the opposing side. When viewing the table top component 16 from a side perspective, a first cutaway portion 30 may be seen. The first cutaway portion 30 may be of any shape as is desired. According to that embodiment shown in FIG. 2, the first cutaway portion 30 is substantially rectangular. A second cutaway portion 32 may further be present on that of the top surface 18 of the first table unit 12. Such a second cutaway portion 32 may also be of any shape as is desired, with that shown in the present embodiment as referenced in FIG. 2 being substantially rectangular in nature. The first and second cutaways 30, 32, when the children's play center 10 is placed in the closed position, may thus substantially align with one another so as to create a handle-like feature 34. The handle-like feature 34, while allowing for the proper alignment of the table top component 16 upon that of the top surface 18, further provides a means of separating the two components by way of lifting the table top component 16 away from that of the top surface 18.

Further present along either of the sides of the table top component 16 are that of circular extrusions 36. Positioned immediately behind each of the circular extrusions 36 is a circular cutout 38. The circular cutout 38 may be further defined as a substantially circular indentation into that of the surface of the table top component 16. The depth to which each of the circular cutouts 38 may extend into the surface of the table top component 16 may vary according to the judgment of those having skill in the art. According to one embodiment of the present invention, as shown in FIG. 2, there may be at least two distinct circular cutouts 38 present along each opposing side of the table top component 16. The circular cutouts 38 may be used for purposes of storing different articles or objects, such as a glass or cup, thus acting in the capacity of a cup holder-type structure with regard to the table top component 16 when the children's play center 10 is placed in the closed position.

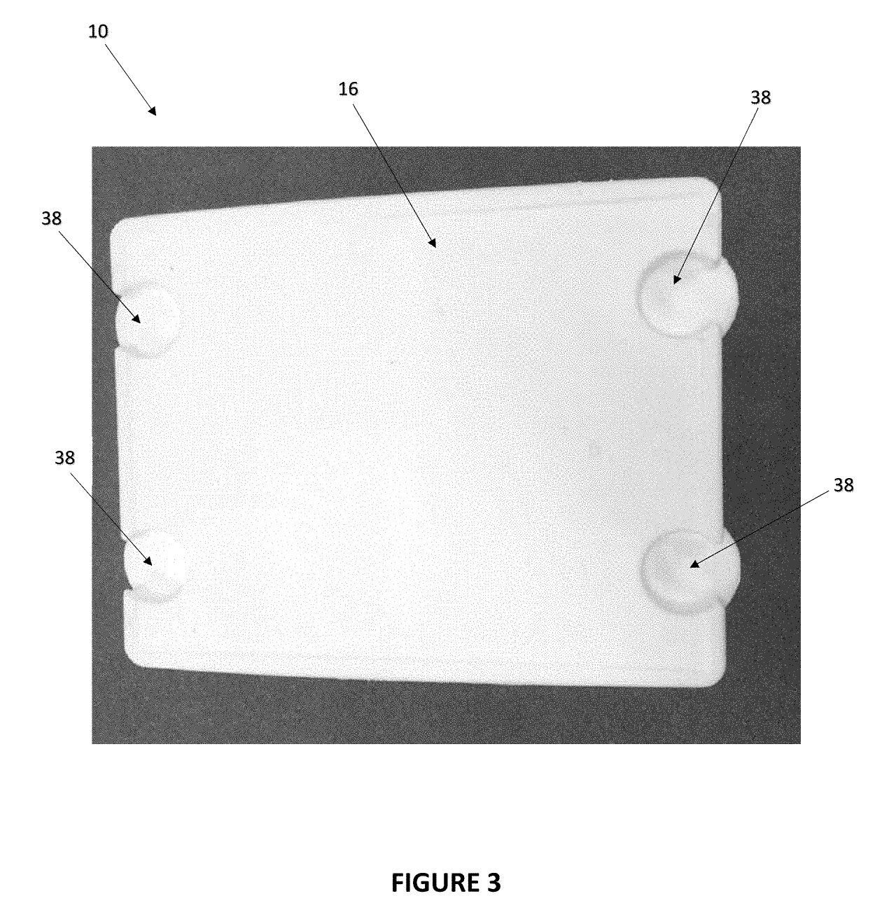

With reference now to FIG. 3, a top or aerial perspective shows the table top component 16 as it may be viewed when the children's play center 10 is placed in the closed position. Positioned on either of the opposing ends of the table top component 16 are each of two circular cutouts 38. The exact location of the circular cutouts 38 may vary according to a number of design parameters which will be discussed in further detail throughout the present disclosure. The outer edges of the table top component 16 may have a lip or other contact surface which is either recessed from, or extrudes beyond, that of the surface of the table top component 16. Such a difference in elevation with respect to the outer edges of the surface allow for a more secured fit of the table top component 16 when positioned on top of that of the first and second table units 12, 14. The top surface 18 of each of the first and second table units 12, 14 may have corresponding variations in depth or elevation such that they are able to receive the table top component 16, or be received by the table top component 16.

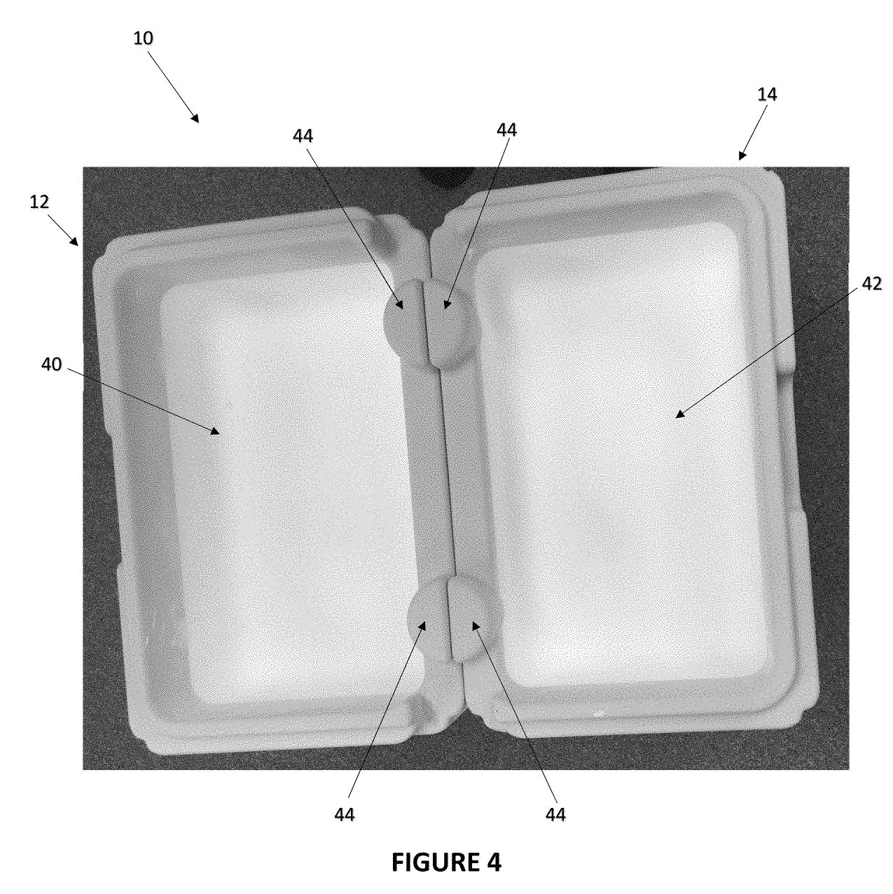

Turning now to FIG. 4, the children's play center 10 may be seen from a top or aerial perspective in the absence of the table top component 16. The first table unit 12 is thus positioned next to the second table unit 14 such that the two units are in contact, or substantially in contact, with one another. With the table top component 16 no longer covering the top portion of each of the respective table units 12, 14, the inner contents of said table units 12, 14 are capable of being seen. The inner contents of the first table unit 12 may further be characterized as that of a first receptacle unit 40, while the inner contents of the second table unit 14 may further be characterized as that of a second receptacle unit 42. Either of the first or second receptacle units 40, 42 may be used for purposes related to storage, or for children's playing purposes. Such children's playing purposes may include, but are not limited to, the filling of either of the receptacle units 40, 42 with sand or water to be used independently or in conjunction with one another.

With continued reference to FIG. 4, the inner face of each of the first and second table units 12, 14, or those faces which are in contact or substantially in contact with one another when said table units 12, 14 are positioned next to one another, each contain at least one notch 44. According to the embodiment shown in FIG. 4, each of said first and second table units 12, 14 contain two such notches 44. The notches 44 of such an embodiment are of a semi-circular, or “half-circle”, design. Further embodiments may allow for the use of any additional shapes or designs of the notches 44 in accordance with the design choice of those having skill in the art. The notches 44 are positioned such that they are capable of acting as a type of guidepost, or receiving post, for that of the table top component 16. When the children's play center 10 is placed in the closed position, the opposing notches 44 of the first and second table units 12, 14 are positioned such that they substantially form a full circle with one another.

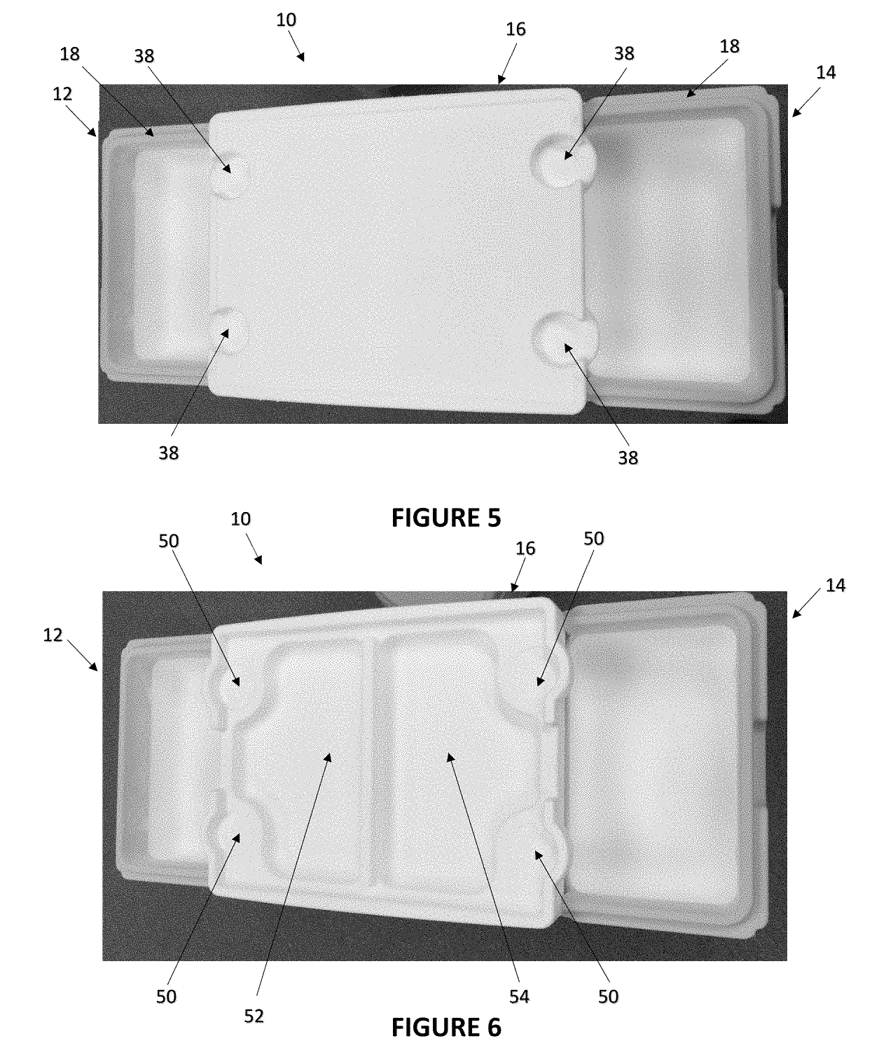

With reference now to FIG. 5, the children's play center 10 is shown when placed in the “open” position. The open position may be generally defined by each of the first and second table units 12, 14 being positioned such that they are not in direct contact with one another. When transitioning from the closed position to that of the open position, the two table units 12, 14 may simply be spaced apart while retaining their general orientation with respect to one another. The distance at which the first and second table units 12, 14 may be positioned apart from one another may be dictated by the size of the table top component 16. According to one embodiment of the present invention, the distance between the first and second table units 12, 14 is substantially the same as that of the length of the table top component 16. The table top component 16 may thus be placed between that of the first and second table units 12, 14 such that it spans the gap between the units. In this position, the table top component 16 may thus be used for a variety of different tasks, such as functioning as an ordinary table surface, or that of a children's play surface for various arts, crafts, or other activities. The table top component 16 may thus be affixed, or rest upon, that of the notches 44 which are present on the top surface 18 of each of the respective first and second table units 12, 14. When the children's play center 10 is in the open position, or any variation thereof, either of the receptacle units 40, 42 may be easily accessed.

According to one embodiment, the table top component 16 is positioned in the same general orientation as that shown in FIG. 3; each of the circular cutouts 38 are facing in an upward direction such that the remainder of the table top component is a substantially flat surface. This configuration will hereinafter be referred to as “open position 1”. Located directly on the reverse side of each of the circular cutouts 38 is a substantially similar feature which is capable of receiving or securing different types of fixtures. Reference to an alternative embodiment of the children's play center 10, when placed in a variation of the open position 1, is helpful to better illustrate the manner in which the table top component 16 is affixed to that of the first and second table units 12, 14.

FIG. 6 illustrates one such alternative embodiment of the children's play center 10 when placed in what will hereinafter be referred to as “open position 2”. The table top component 16 may be rotated, or flipped over, 180 degrees such that the bottom most surface is now facing in the upward direction. Such a reversal of the table top component 16 reveals the underside of each of the circular cutouts 38, further referenced now as receiving units 50. The receiving units 50, according to the present embodiment, are similar to that of the circular cutouts 38 in that they have a substantially circular structure, however various other embodiments utilizing structures of differing shapes may be used according to the judgment of those having skill in the art. According to the embodiment shown in FIG. 6, a series of contoured edges are present on the underside of the table top component 16 such that the receiving units 50 are generally defined by such edges. The contoured edges are raised with respect to that of the surface of the table top component 16 such that the receiving units 50 have a cavity-like appearance. The various contoured edges located on the underside of the table top component 16 may further define additional cavities 52, 54 which may be used for a variety of activities. Additional variations to the cavities 52, 54 may be utilized, such as that of a single cavity or a multitude of cavities, as identified by those having skill in the art.

With regard to each of FIGS. 5 and 6, the various components shown in each respective figure are helpful in illustrating the attachment of the table top component 16 to that of the first and second table units 12, 14. When placed in open position 1, as shown in FIG. 5, the receiving units 50 are capable of receiving each of the available notches 44 which are exposed by each of said table units 12, 14. The notches 44 may allow for the table top component 16 to rest substantially thereon in a supportive manner, or may further allow for the table top component 16 to have a secured attachment thereto, according to the preferences of those having skill in the art. In a similar manner, when placed in open position 2, as illustrated by FIG. 6, the circular cutouts 38 are capable of receiving each of the available notches 44 which are exposed by each of said table units 12, 14. The notches 44 may allow for the table top component 16 to rest substantially thereon in a supportive manner, or may further allow for the table top component 16 to have a secured attachment thereto, according to the preferences of those having skill in the art.

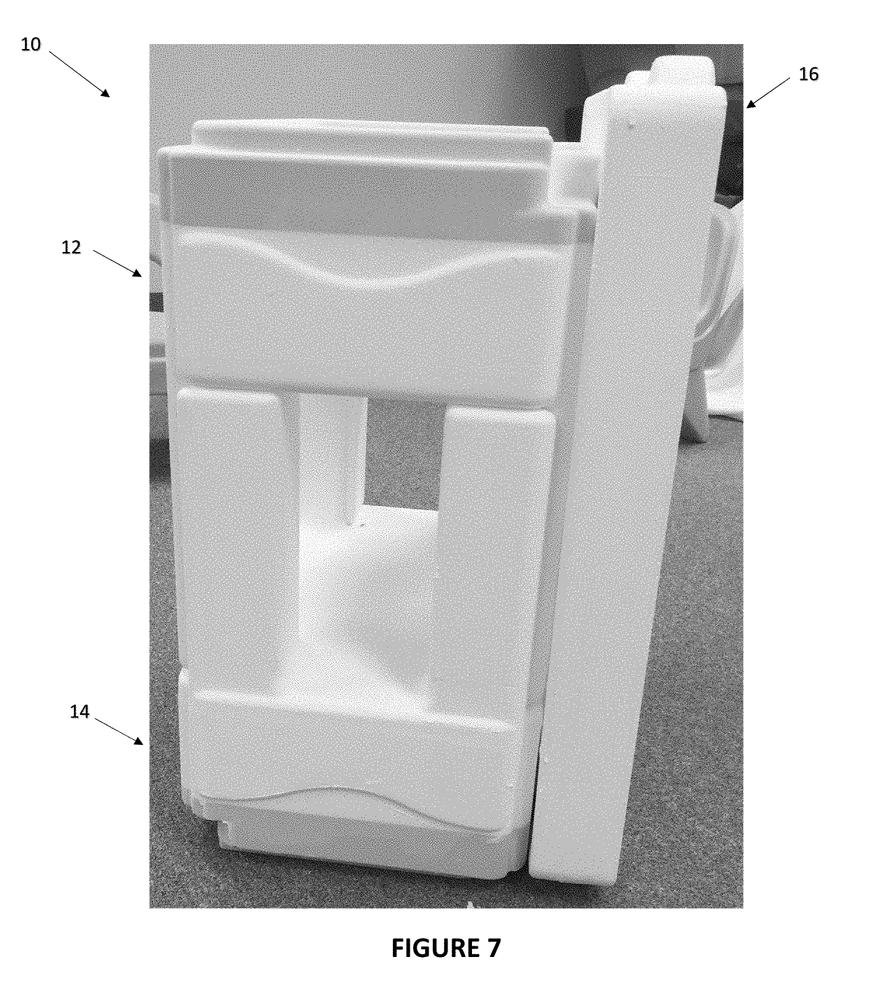

With reference now to FIG. 7, the children's play center 10 may further be placed in a collapsed position, referred to in the remainder of the present disclosure as the storage position. The storage position may generally be defined by the ability of the first and second table units 12, 14 to fit together at opposing ends such that they create a single unit having a generally rectangular shape. The manner in which the first and second table units 12, 14 fit together is generally dictated by the alignment of the supporting legs. The detailed structure of the supporting legs will be discussed in greater detail throughout the present disclosure. The table top component 16 may further be aligned when placing the children's play center 10 in the storage position by being placed against either of the respective sides of the first and second table units 12, 14 upon their being positioned together.

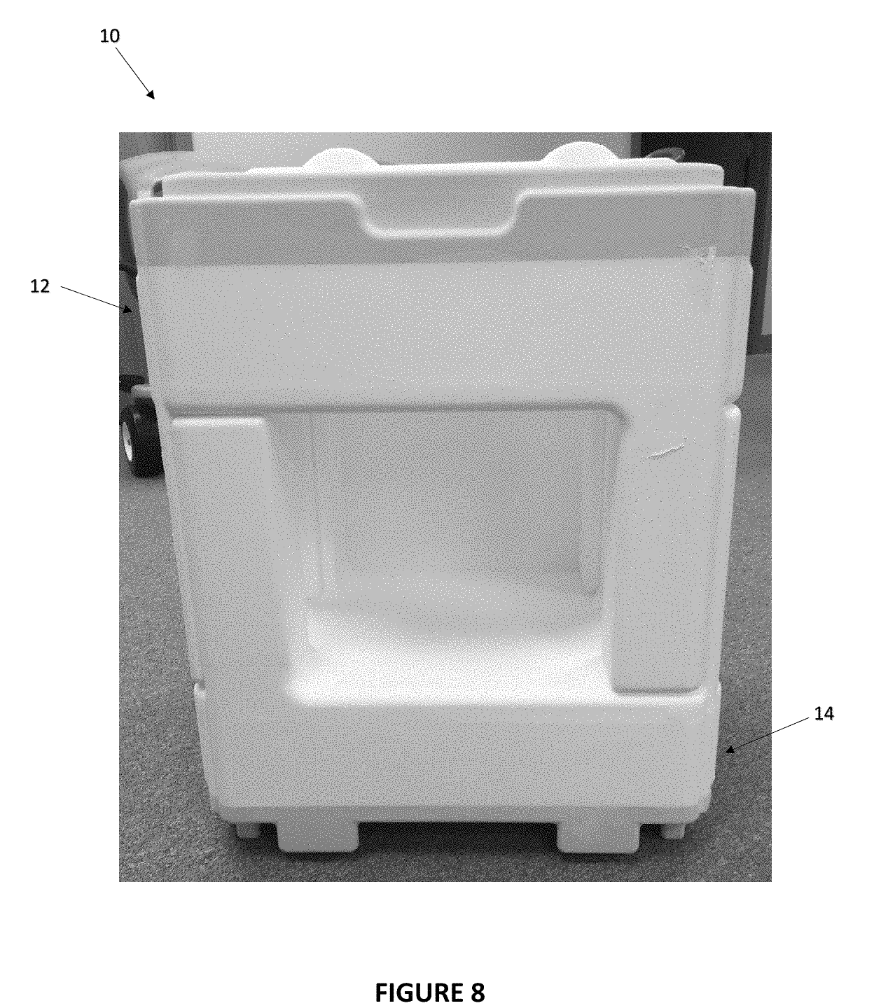

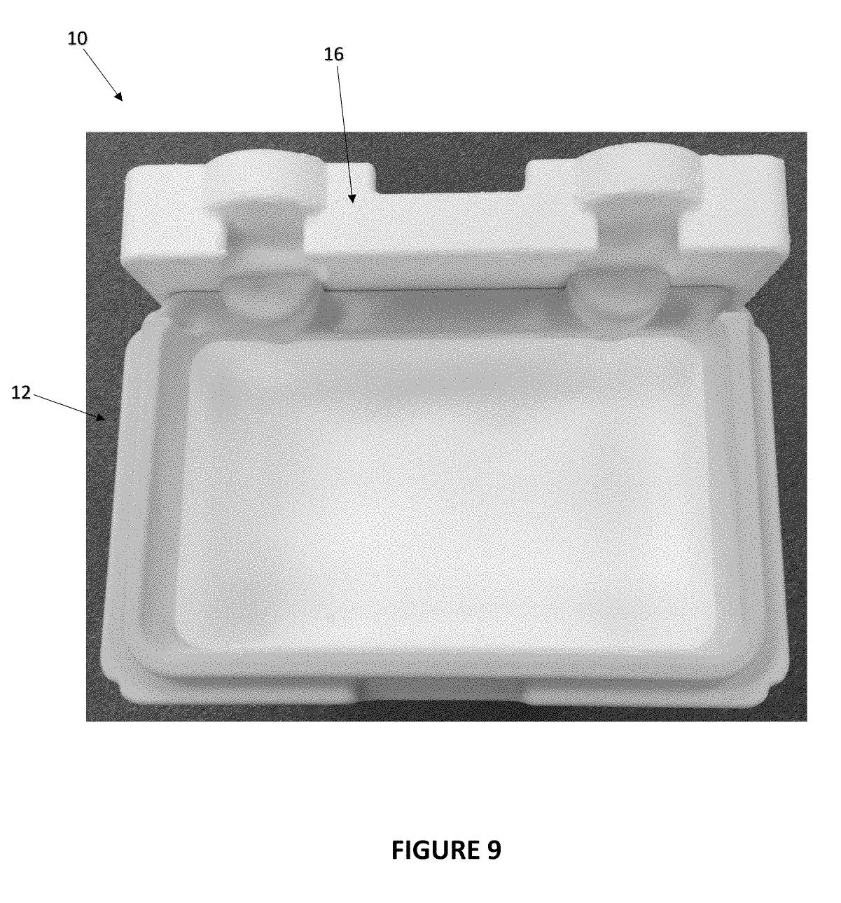

FIG. 8 shows an alternative view of the children's play center 10 when placed in the storage position. This alternative view helps to illustrate the interaction between that of the first and second table units 12, 14 when placed in such a collapsed position. FIG. 9 further encompasses the children's play center 10 when viewed from an aerial perspective. Such a top-down view shows the interaction between that of the table top component 16 and the table units 12, 14.

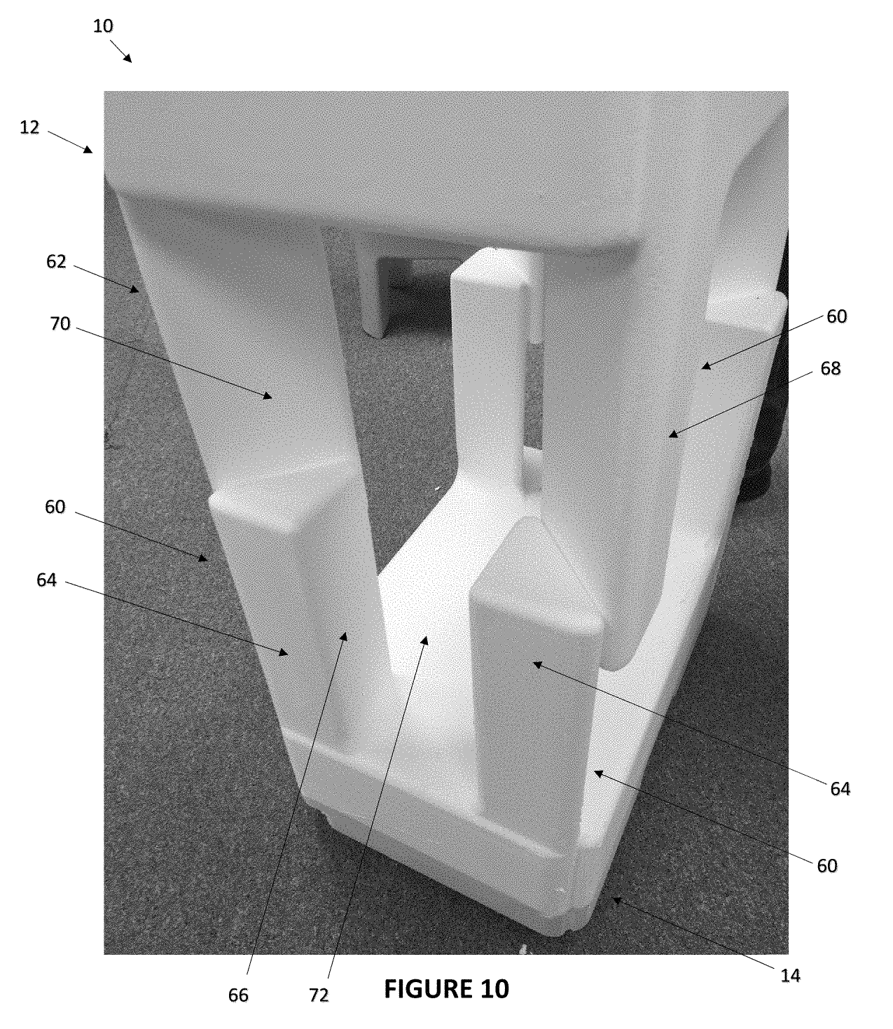

Turning now with reference to FIG. 10, the structure of the supporting legs may be seen as they relate to the ability to place the children's play center 10 in the storage position. The supporting legs may fall into one of two general categories of structure; an outer support leg 60 or an inner support leg 62. According to the present embodiment, each support leg, regardless of which type of structure under which it is classified, has a corresponding support leg of the opposite classification; for each outer support leg 60 there is a corresponding inner support leg 62.

Each of the outer support legs 60 may be generally defined by having a triangular structure such that there are generally three faces. The exact dimensions of the faces may vary according to the desires of those having skill in the art. A first face 64, of the outer leg 60, is positioned such that it lays substantially flush with that of an outer edge of the narrow end of the respective table unit to which it is affixed. A second face 66, of the outer leg 60, is positioned such that it is perpendicular, or substantially perpendicular, to that of the first face 64, such that the first and second faces 64, 66 form a 90 degree, or substantially 90 degree, angle with one another. The orientation of the 90 degree, or substantially 90 degree, angle will be such that it lays to the inside position of the outer leg 60. A third face, of the outer leg 60, which is not visible in FIG. 10, thus completes the triangular structure of the outer leg 60. With a table unit containing a typical four leg distribution, those two legs which are affixed to the same end of the table unit which spans the more narrow width of such a table unit will be of the same structure, i.e. either both outer legs 60 or both inner legs 62.

Each of the inner support legs 62 may also be generally defined by having a triangular structure such that there are generally three faces. The exact dimensions of the faces may vary according to the desire of those having skill in the art. A fourth face 68, of the inner leg 62, is positioned such that it lays substantially flush with that of an outer edge of the longer end of the respective table unit to which it is affixed. A fifth face, of the inner leg 62, is positioned such that it is perpendicular, or substantially perpendicular, to that of the fourth face 68, such that the fourth face 68 and the fifth face form a 90 degree, or substantially 90 degree, angle with one another. The orientation of the 90 degree, or substantially 90 degree, angle will be such that it is aligned along that of the outer edge of the table unit to which the inner leg is affixed. A sixth face 70, of the inner leg 62, thus completes the triangular structure of the inner leg 62.

When positioning the first and second table units 12, 14 in the storage position, each of the inner legs 62 are capable of being placed such that the third face of each of the outer legs 60 lays flush against that of the sixth face 70 of the inner legs 62. As each of the respective first and second table units 12, 14 are comprised of two outer legs 60 and two inner legs 62, such a placement of the table units with respect to the alignment of the supporting leg faces will result in the children's play center 10 being placed in the storage position. Either of the outer legs 60 and inner legs 62 may thus be placed in such a position until such a point where the bottom surface of the respective legs contacts that of the underside of the table unit 72.

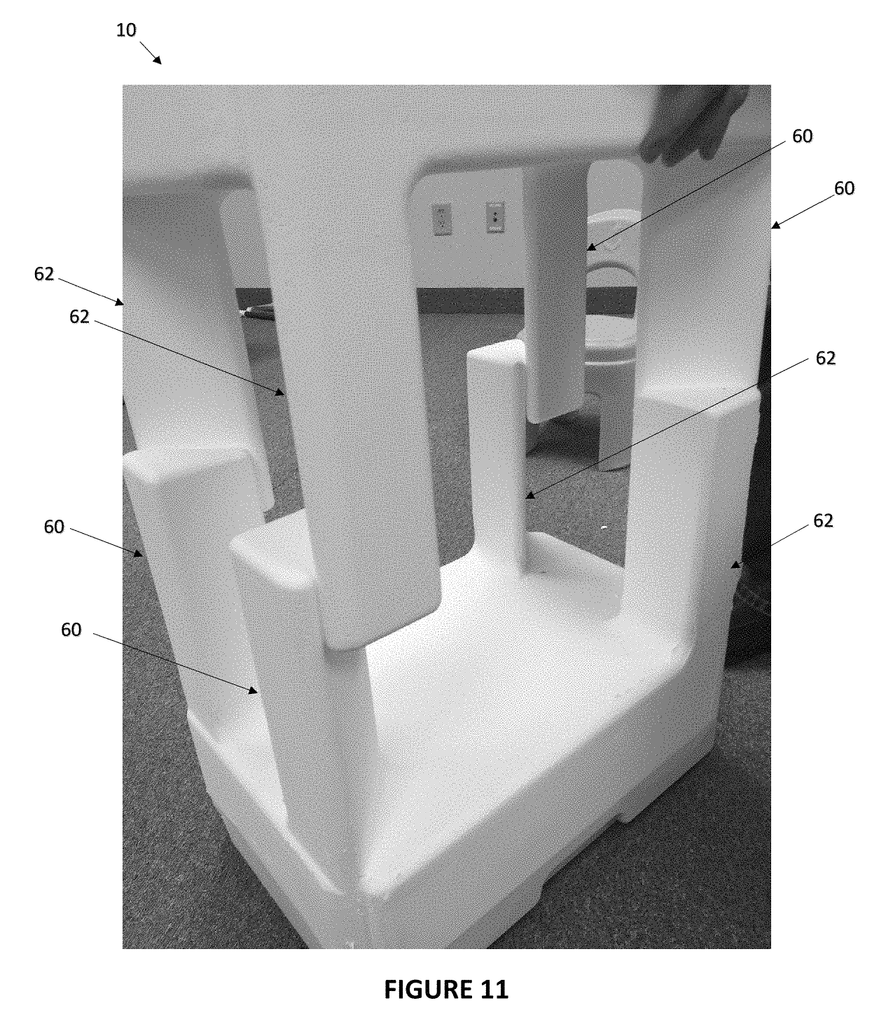

An alternative view of the children's play center 10 transitioning to that of the storage position is shown in FIG. 11. This alternative view illustrates the presence of each of two outer legs 60 and two inner legs 62 being present on each of the respective table units 12, 14. By aligning each set of legs with that of their corresponding counterpart, the table units 12, 14 can thus be “inserted” into one another so as to achieve the storage position. Once the children's play center 10 has been placed in the storage position, while taking up a much smaller volume of physical space, the unit is further capable of being more easily transported from one location to another. Such an ease of transportation may range from that of the simple moving of the children's play center 10 from one location to another, to that of industrial shipping applications in which multiple units are needed to be stacked or otherwise positioned in a space efficient manner.

As described above, the present disclosure has been described with preferred embodiments thereof and it is understood that many changes and modifications to the described embodiments can be carried out without departing from the scope and the spirit of the present disclosure that is intended to be limited only by the appended claims.

Having thus described the invention, it is now claimed:

I claim:

1. A children's play center comprising:
a first table unit, said first table unit further comprising at least one set of inner supporting legs, at least one set of outer supporting legs, and at least one attachment notch;
a second table unit, said second table unit further comprising at least one set of inner supporting legs, at least one set of outer supporting legs, and at least one attachment notch, and;
a table top component, said table top component further comprising at least two sets of receiving units located on either side of said table top component;
wherein the at least one attachment notch of the first table unit is capable of being received by at least one receiving unit of the table top component, at least one attachment notch of the second table unit is capable of being received by at least one receiving unit of the table top component, the inner supporting legs of the first table unit are capable of receiving the outer supporting legs of the second table unit, and the outer supporting legs of the first table unit are capable of receiving the inner supporting legs of the second table unit.

2. The children's play center of claim 1 wherein the first and second table units are positioned such that they are in contact, or substantially in contact, with one another such that the at least one attachment notch of the first table unit is alongside that of the at least one attachment notch of the second table unit.

3. The children's play center of claim 2 wherein the table top component is positioned on top of that of the first and second table units.

4. The children's play center of claim 1 wherein the first and second table units are positioned sufficiently far away from one another.

5. The children's play center of claim 4 wherein the table top component spans the gap created between that of the first and second table units.

6. The children's play center of claim 5 wherein the at least one attachment notch of the first table unit is received by at least one receiving unit on the table top component.

7. The children's play center of claim 6 wherein the at least one attachment notch of the second table unit is received by at least one receiving unit on the table top component.

8. The children's play center of claim 7 wherein each of the first and second table units are capable of further being utilized as a receptacle unit.

9. The children's play center of claim 8 wherein the table top component is rotated such that the opposing side is now capable of being received by the attachment notches of the first and second table units.

10. The children's play center of claim 1 wherein the first table unit is inserted into the second table unit such that the outer supporting legs of the first table unit are in contact, or substantially in contact, with that of the inner supporting legs of the second table unit, and the inner supporting legs of the first table unit are in contact, or substantially in contact, with that of the outer supporting legs of the second table unit.

11. The children's play center of claim 10 wherein the table top component is affixed to one side of each of the first table unit and second table unit.

12. A children's play center comprising:
a first table unit, said first table unit further comprising one set of inner supporting legs, one set of outer supporting legs, and two attachment notches;
a second table unit, said second table unit further comprising one set of inner supporting legs, one set of outer supporting legs, and two attachment notches, and;
a table top component, said table top component further comprising two sets of two receiving units located on either side of said table top component;
wherein the two attachment notches of the first table unit are capable of being received by at least two of the receiving units of the table top component, at least two of the attachment notches of the second table unit are capable of being received by at least two of the receiving units of the table top component, each of the first and second table units are further capable of being used as a receptacle unit, the pair of inner supporting legs of the first table unit are capable of receiving the pair of outer supporting legs of the second table unit, and the pair of outer supporting legs of the first table unit are capable of receiving the pair of inner supporting legs of the second table unit.
